(19) United States
(12) Patent Application Publication
(10) Pub. No.: US 2019/0133080 A1
(43) Pub. Date: May 9, 2019

(54) A ANIMAL TRAINING APPARATUS AND METHOD

(71) Applicant: Danny Wilson, San Diego, CA (US)

(72) Inventor: Danny Wilson, San Diego, CA (US)

(21) Appl. No.: 16/097,834

(22) PCT Filed: May 1, 2017
(86) PCT No.: PCT/US17/30477

§ 371 Date: Oct. 30, 2018

Related U.S. Application Data
(60) Provisional application No. 62/330,099, filed on Apr. 30, 2016.

(51) Int. Cl. A01K 15/02; A01K 5/01

(52) U.S. Cl. CPC A01K 15/025; A01K 5/0114

(57) ABSTRACT

A novel animal training apparatus and method for relieving various emotional and psychological issues in animals in captivity, including separation anxiety, boredom, depression and keeping the animal intellectually engaged by attempting to obtain a food treat from inside the animal training apparatus.

### PRIORITY CLAIM

This United States non provisional National Phase patent application claims the benefit of priority to earlier filed Patent Cooperation Treaty Application Serial Number PCT/US2017/030477, entitled, “A ANIMAL TRAINING APPARATUS AND METHOD”, to Wilson, filed May 1, 2017, which in turn claims the benefit of priority to U.S. provisional patent application Ser. No. 62/330,099, filed Apr. 30, 2016 to Wilson.

### BACKGROUND

### Field

The present invention relates generally to animal training apparatuses and methods, which help address psychological and emotional issues arising in animals held in captivity, such as for example domesticated pets, zoo animals, or aquamarine animals.

### Related Art

There are various known devices for dispensing animal food stored within them. Such food dispensers are often circular or cylindrical in shape and dispense food through openings in the device by rotating one or more parts. See, for example, U.S. Pat. Nos. 5,003,925; 5,213,232; and 5,232,130. One disadvantage of such devices is that they generally fail to provide proper exercise or amusement for an animal or pet. Moreover, even a food dispenser designed to give some amusement and exercise, such as the feeder disclosed in U.S. Pat. No. 3,999,519 for small animals, is not practical for larger pets such as dogs.

Additionally, there are various pet toys for amusement only but which do not contain animal food as an enticement and reward. A conventional cat toy includes a spherical hollow external ball having holes and containing a smaller opaque ball. The holes allow the cat to insert its paw and play with the internal ball. See U.S. Pat. No. 5,351,650. A pet toy that is a variation on this concept is disclosed in U.S. Pat. No. 5,009,193. The external compartment is a toroidal enclosure which includes an opening that is large enough for the ball inside to be removed by the cat. While toys of this type may entertain the pet for a time, such toys do not entice or reward the pet with a treat.

Animal toys for the amusement and diversion of the pet which emanate various sounds when squeezed, shaken or rolled are also known, but these toys often fail to properly entice or reward the pet with a treat.

Other pet toys are known to combine amusement with dispensing food, such as treat-discharging toys or balls. Typical treat-discharging animal or pet toys are filled with treats such as artificial bones or other edible objects. The treat toy discharges the treats in response to pushing or shaking by an animal, usually a pet such as a dog. Such treat toys include holes large enough for the treat to pass through when pulled out by the pet or animal. See U.S. Pat. No. 5,343,828. Alternatively, treats fall through the holes randomly as the treat ball, which is typically spherical, rolls when played with by the pet. See U.S. Pat. No. 5,819,690.

However, these conventional pet treat balls also have several disadvantages. One disadvantage is that the treat balls are typically spherical in shape, and thus roll in a regular manner when played with, which may translate to eventual boredom for the animal. Another disadvantage is that the rate of dispensation of the treats is limited by the fixed size and shape of the holes in the ball.

U.S. Pat. No. 2,086,631 discloses a spherical cat toy adapted to dispense catnip including circular and elongated duct means and closure means constructed to close, partially open and completely open the duct means. However, the cat toy disclosed in the '631 patent is spherical, which could lead to boredom and disinterest. Also, the '631 patent discloses that the treat ball is necessarily weighted in some embodiments in order to prevent the toy from rolling great distances. Also, the opening and closing of the duct means is effected by adjusting portions of the spherical ball itself, and does not provide for a separate adjustment mechanism. Moreover, the treat within is not visible to the cat when the ducts are closed.

The present teachings solve these problems, as will now be described.

### SUMMARY

In one embodiment, an animal training apparatus is disclosed, having an upper portion, having a plurality of chambers wherein at least one chamber comprises a food passage hole therein, including an open barrier and a closed barrier, further comprising a lower portion, having a plurality of chambers wherein at least one chamber comprises a food passage hole therein, including an open barrier and a closed barrier. The animal training apparatus further comprises a locking portion, adapted to lock the upper portion and the lower portion in a fixed position with respect to each other.

### BRIEF DESCRIPTION OF THE DRAWINGS

Embodiments of the present disclosure will be more readily understood by reference to the following figures, in which like reference numbers and designations indicate like elements.

FIG. 1a illustrates a cross sectional view of a circumferentially locking embodiment of an animal training apparatus, according to the present teachings.

FIG. 1b illustrates a cross sectional view of a top half of a circumferentially locking embodiment of an animal training apparatus, according to the present teachings.

FIG. 1c illustrates a cross sectional view of a bottom half of a circumferentially locking embodiment of an animal training apparatus, according to the present teachings.

FIG. 2 illustrates a perspective view of a circumferentially locking embodiment of an animal training apparatus, according to the present teachings.

FIG. 3 illustrates a side view of two separated halves of a circumferentially locking embodiment of an animal training apparatus, according to the present teachings.

FIG. 4 illustrates a side view of one half of a circumferentially locking embodiment of an animal training apparatus, according to the present teachings.

FIG. 5 illustrates top plan view of the inside of one half of a circumferentially locking embodiment of an animal training apparatus, according to the present teachings.

FIG. 6a illustrates a perspective view of disassembled top and bottom halves of an interlocking embodiment of an animal training apparatus, according to the present teachings.

FIG. 6b illustrates a perspective view of the inside of disassembled top and bottom halves of an interlocking embodiment of an animal training apparatus, according to the present teachings.

FIG. 6c illustrates a perspective view of disassembled top and bottom halves of an interlocking embodiment of an animal training apparatus, according to the present teachings.

FIG. 7 illustrates a zoomed in perspective view of the inside of one half of a circumferentially locking embodiment of an animal training apparatus, according to the present teachings.

FIG. 8 illustrates a perspective view of the inside of disassembled top and bottom halves of a circumferential ridge locking embodiment of an animal training apparatus, according to the present teachings.

FIG. 9 illustrates a perspective view of disassembled top and bottom halves of a circumferential ridge locking embodiment of an animal training apparatus, according to the present teachings.

FIG. 10 illustrates a perspective view of disassembled top and bottom halves of a circumferential ridge locking embodiment of an animal training apparatus, according to the present teachings.

FIG. 11 illustrates a top plan view of disassembled top and bottom halves of a circumferential ridge locking embodiment of an animal training apparatus, according to the present teachings.

FIG. 12 illustrates a perspective view of the inside of disassembled top and bottom halves of a circumferential ridge locking embodiment of an animal training apparatus, according to the present teachings.

### DETAILED DESCRIPTION

Domestication of animals has been an aspect of human culture for thousands of years. Embodiments of the present teachings help animals in captivity deal with psychological and emotional issues that may arise during captivity and/or domestication. Examples of such issues may be separation anxiety when an owner leaves a dog or cat at home alone, which can lead to stress for the animal and undesirable behaviors if the animal acts out. Other animals such as horses may also exhibit behaviors associated with anxiety and/or boredom, such as windsucking. Even animals held in captivity, but not domesticated such as in a zoo or large aquarium-type facility may also experience adverse psychological and emotional issues associated with being deprived of their natural habitat.

Embodiments of the present teachings may be used for relief from psychological and/or emotional issues in literally any animal held in captivity or domesticated by adapting the disclosed teachings suitable for a particular animal. For example, when used for dogs, varying sizes of an animal training apparatus may be scaled depending upon the size of dog. Likewise, when adapted for use with a dog, the reward inside the animal training apparatus should be a dog treat.

It will be appreciated that embodiments of the present teachings may also be adapted for a therapy tool for deaf and blind dogs. Deaf and blind dogs are attracted to the scent of food, therefore if a dog treat is placed within an embodiment of the disclosed invention, the handicapped dog will have a natural motivation to exercise their brain and body, which is important for the overall physical and mental health of the dog. Moreover, because deaf or blind dogs have fewer senses than other dogs with full capacity, embodiments of the present teachings provide tactile stimulation, which supports brain development and overall well being of the animal.

The present teachings disclose a holistic animal behavior modification tool, which also helps exercise the animals body and mind by creating a problem for the animal which it must solve in order to be rewarded with a food treat inside that the animal can smell and is therefore incentivized for the animal to obtain and concentrate upon. For example a dog may use its mouth and/or paws to work the dog treat out of the animal training apparatus of the present disclosure. In another application of the present teachings, a dolphin may chase the animal training apparatus, modified such that it may get its nose underneath it, around a tank to try and work a fish treat out of the animal training apparatus.

Benefits of the present teachings include, inter alia, relieving boredom in a captive animal, relieving separation anxiety, keep the animal at a healthy weight, it may be used as a food delivery system, a reward system, exercise and further used as a behavior modification tool.

It will be appreciated that in field trials testing the disclosed embodiments of the present disclosure, over 100 dogs tested have enjoyed the opportunity to have aerobic exercise, in that all dogs participating “pawed” at the animal training apparatus in a manner consistent with “fast digging motion” when the apparatus was flat on the ground. Literally 100% of the dogs participating in this field trial exhibited this behavior and appeared to all have accelerated cardiovascular rates.

As experts in dog training will appreciate, a dog has a natural instinct to derive pleasure from something that reacts to the dog's teeth biting into an object. For example, dogs enjoy biting into inflated objects, such as a tennis ball, but then lose interest after the tennis ball has been deflated, which is because dogs enjoy the reflex action of the object, as it pushes back against the dog's biting action. Some dog experts have a hypothesis that this is because endorphins in the dog's brain are released during such reflexive action. Also, notably, this reflexive reaction to the dog's bite also causes a form of mental stimulation, which is another reason why dogs enjoy chewing on tennis balls. Embodiments of the present teachings allow a dog to benefit from such action, but in a far improved manner, as there is a treat the dog can smell and be incentived by, and there is never a deflation of the animal training apparatus.

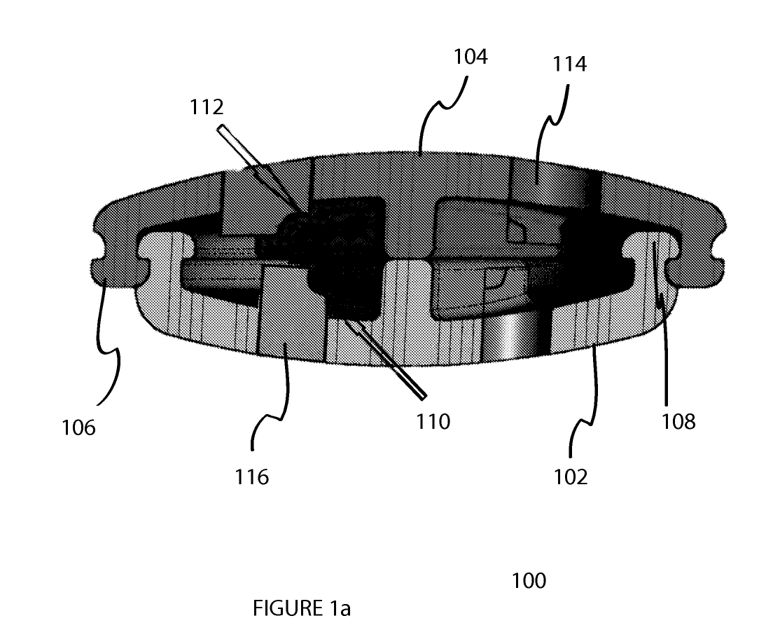

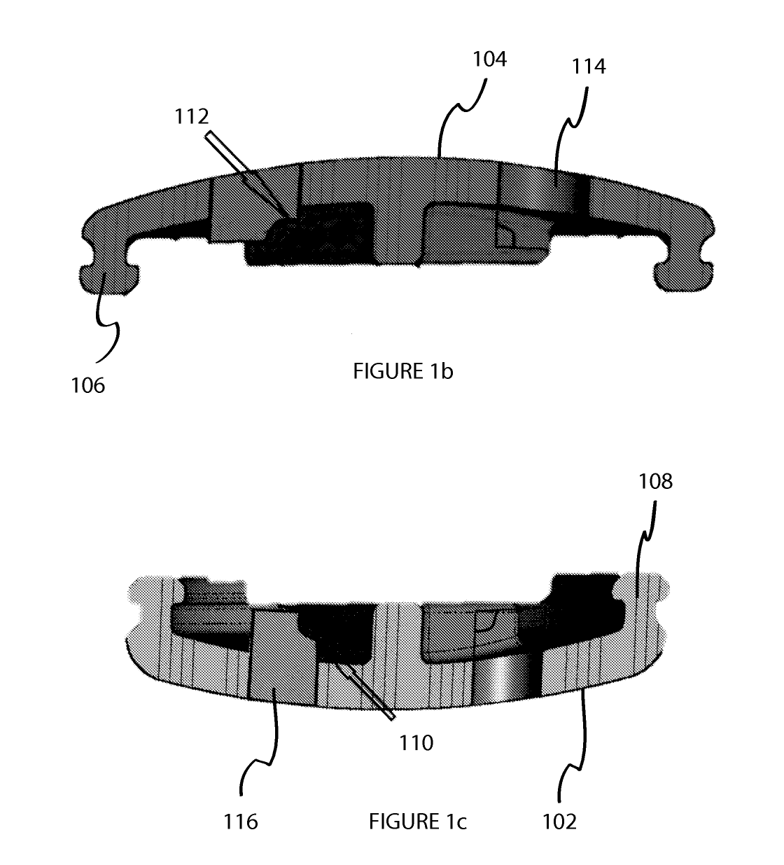

Referring now generally to FIG. 1a, FIG. 1b, and FIG. 1c, a cross sectional view of a circumferentially locking embodiment of an animal training apparatus 100, according to the present teachings is illustrated. The circumferentially locking embodiment of the animal training apparatus 100 comprises a bottom portion 102, having at least one chamber 110, at least one food passage hole 116 and a bottom half circumferential locking portion 108. The circumferentially locking embodiment of the animal training apparatus 100 further comprises a top portion 104, having at least one chamber 112, at least one food passage hole 114, and a top half circumferential locking portion 106. This embodiment is circumferentially locking in the sense that the bottom half circumferential locking portion 108 is adapted to be press fitted by a human user's hand into the top half circumferential locking portion 106, such that the top portion 104 and the bottom portion 102 are “locked” together in such a manner that the respective portions are static with respect to each other.

The animal training apparatus 100 is composed of a flexible material, such as for example polyurethane rubber. Literally any material that provides a spring-like restoring force as in Equation 1 below may be used to construct the animal training apparatus 100.

F=−kX Equation 1:

As shown in Equation 1, a restoring force, “F”, is defined by a distance travelled, “X”, with a spring constant, “k”.

It will be appreciated that the animal training apparatus 100 is a food based tool, which occupies the animal's interest and time. In one exemplary embodiment, the animal training apparatus 100 is adapted for use with a dog, which may be given to a dog when an owner leaves to keep the dog from experiencing separation anxiety. Moreover, the animal training apparatus 100 may also be used to keep an animal intellectually engaged to mitigate the boredom associated with domestication or captivity. Emotionally, animals kept in captivity, such as in zoos or domesticated animals in human homes, are susceptible to boredom and depression. Embodiments of the animal training apparatus 100 directly addresses these issues, as will be described further below.

As used herein, the term, “reactive” addresses an issue animals enjoy. For example, when an animal “plays” with a ball, a part of the intrigue is the spring-like quality of the ball in the mouth of the animal. When the animal bites down on the ball and the ball springs back against the mouth of the animal, the animals is engaged physically and mentally. This is one reason why when a dog has worn out the reactive nature of a ball and the ball goes flat, the dog is no longer interested in that particular ball.

FIG. 1a, FIG. 1b, and FIG. 1c, show a cross sectional view of a circumferentially locking embodiment of the animal training apparatus 100, wherein the bottom half circumferential locking portion 108 of the bottom portion 102, may be easily press fitted together by the hands of a human user, with the top half circumferential locking portion 106 of the top portion 104. Once locked in place, the bottom portion 102 does not move relative to the top portion 104. Prior to locking the bottom portion 102 into place with the top portion 104, the human user places an animal food treat into one or more of the at least one chambers 112. Once the animal training apparatus 100 has been assembled and locked into place, the animal can smell the food treat naturally and is enticed to play with it to extract the food treat by manipulating the animal training apparatus 100 such that the food treat is moved through the at least one chamber 110 into a chamber wherein the at least one food passage hole 116 is disposed. Once in the at least one chamber 110, the animal can more distinctly smell the food treat naturally and is more excited to extract the food treat through the elongate aperture of the at least one food passage hole 116. It will be appreciated that the food treat does not simply fall out of the at least one food passage hole 116 once in the at least one chamber 110, as the elongate aperture is narrower than the food treat. That is, the food treat is smaller than the holes in the animal training apparatus 100. The animal is enticed to manipulate the food treat through different chambers of the animal training apparatus 100 by either using a mouth to chew on it, or to move the animal training apparatus 100 around with its paws. As will be described in greater detail below, the food treat may be moved between each chamber of the animal training apparatus 100 via narrow openings between each chamber. The dog is naturally enticed to play with the animal training apparatus to attempt to extract the food treat.

It will be appreciated that the animal training apparatus 100 may be manually set by a human user into either an easy mode or a hard mode, as will now be described in greater detail.

### Easy Mode

As illustrated most readily in FIG. 1b and FIG. 1c, the bottom portion 102 may comprise as least one food passage hole 116 and the top portion 104 may comprise at least one food passage hole 114. In an “easy mode”, the human user aligns the at least one food passage hole 114 of the top portion 104 to be opposite at least one chamber 110 of the bottom portion 102, wherein the at least one chamber 110 of the bottom portion 102 does not have a food passage hole. In one embodiment, the top portion 104 comprises two food passage holes and four chambers and the lower portion 102 comprises two food passage holes and four chambers. In this variation, the “easy mode” is set by a human user such that each food passage hole of the upper portion 104 is aligned with a corresponding at least one chamber of the bottom portion 102 which does not have a food passage hole. In this configuration, there is effectively a food passage hole in every chamber through which the food treat may pass, either through the top portion 104 or through the bottom portion 102. It will be appreciated that in this mode, it will be easier for the animal to remove the food treat from the animal training apparatus 100, because there is effectively a food passage hole in every chamber.

### Hard Mode

As illustrated most readily in FIG. 1b and FIG. 1c, the bottom portion 102 may comprise at least one food passage hole 116 and the top portion 104 may comprise at least one food passage hole 114. In a “hard mode”, the human user aligns the at least one food passage hole 116 of the bottom portion 104 with the at least one food passage hole 114 of the top portion 102. In one embodiment, the top portion 104 comprises two food passage holes and four chambers and the lower portion 102 comprises two food passage holes and four chambers. In this variation, the “hard mode” is set by the human user such that each food passage hole of the upper portion 104 is aligned with a corresponding opposite chamber of the lower portion 102 which also contains a food passage hole, wherein the upper and lower food passage holes are substantially aligned. In this configuration, there are effectively two chambers of the animal training apparatus 100 which have no food passage holes, and two chambers which do have food passage holes. Therefore, one aspect of this configuration is that there are 50% of the chambers from which no food may pass out of the animal training apparatus 100, and 50% of the chambers from which the food may pass through either the at least one food passage hole 114 and/or through the at least one food passage hole 116. Because the animal must manipulate the food treat into a chamber having a food passage hole, for which only 50% of the chambers contain in this configuration, it is more difficult for the animal to access the food treat to remove it from the animal training apparatus 100. Moreover, because the at least one food passage hole 114 is substantially aligned with the at least one food passage hole 116, the spacing clearance for the food treat to enter either food passage hole elongate aperture is limited, because neither upper or lower chamber, in this configuration has an opposing empty chamber. That is, because the upper and lower portions have aligned food passage holes that protrude internally into their respective chambers, the clearance through which the food treat may pass is more limited than if there were no opposing food passage chamber in the opposing portion.

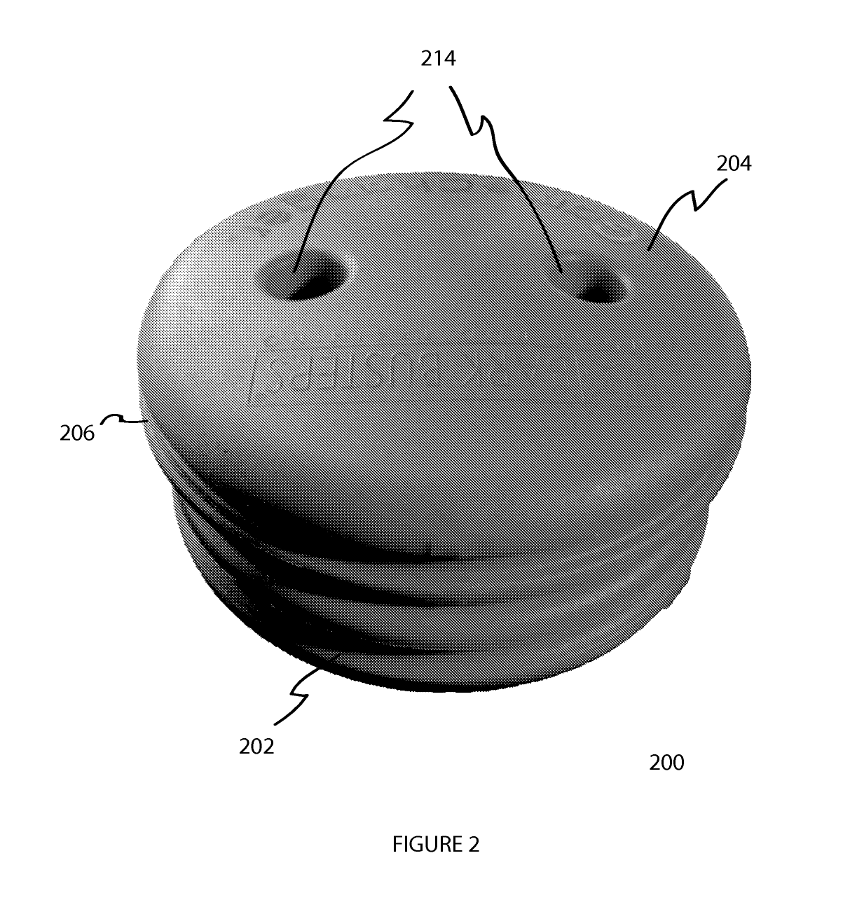

Referring now to FIG. 2, a circumferentially locking embodiment of the animal training apparatus 200 is illustrated, comprising a bottom portion 202, having at least one chamber (not shown), at least one food passage hole (not shown) and a bottom half circumferential locking portion (not shown). The circumferentially locking embodiment of the animal training apparatus 200 further comprises a top portion 204, having at least one chamber (not shown), at least one food passage hole 214, and a top half circumferential locking portion 206.

As described above with respect to FIG. 1a, FIG. 1b and FIG. 1c, the embodiment of FIG. 2 is circumferentially locked by a human user, subsequent to a food treat being placed into one or more of the internal chambers. The animal training apparatus 200 is set into either an easy mode or a hard mode, as described above and then given to the animal. The animal may manipulate the animal training apparatus 200 by chewing on it or using paws to move it around, whereby the food treat may be moved into a chamber having a food passage hole, through which the animal may then attempt to work the food threat out of the animal training apparatus 200 through the food passage hole. It will be appreciated that the disclosed animal training apparatus 200 operates to keep an animal physically and intellectually engaged due to the spring-like quality of the materials from which the animal training apparatus 200 is composed and also due to the enticement of smelling an accessible treat within the animal training apparatus 200. In one embodiment, the animal training apparatus 200 is made of rubber.

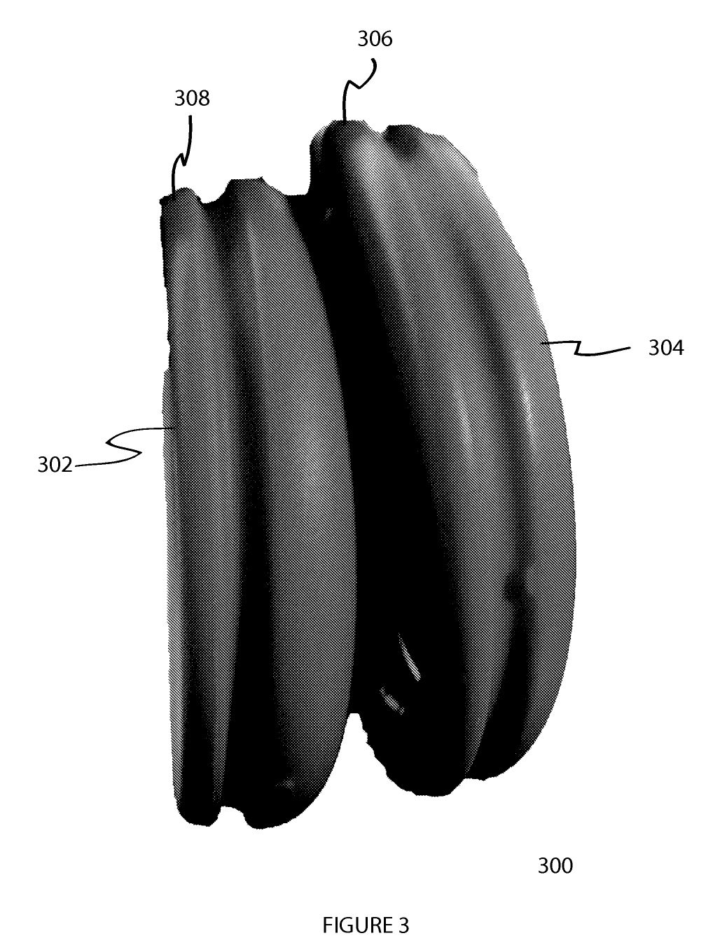

Referring now to FIG. 3, a disassembled side plan view of an animal training apparatus 300 is illustrated, comprising a bottom portion 302, having a bottom half circumferential locking portion 308, and a top portion 304 having a top half circumferential locking portion 306. This side plan view illustrates the circumferential arc oriented about the perimeter of the animal training apparatus 300. It will be appreciated that the diameter of the bottom portion 302 is smaller than the diameter of the top portion 304, such that when a force is applied to press fit the bottom portion 302 into the top portion 304, the two portions will be locked into place via the bottom half circumferential locking portion 308 fitting entirely with the top half circumferential locking portion 306.

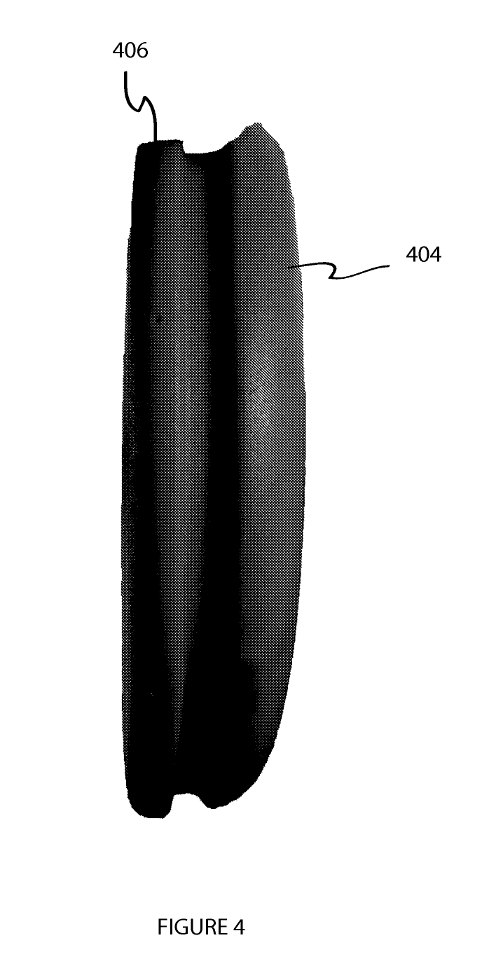

FIG. 4 illustrates a side plan view of a top half circumferential locking portion 404 embodiment of a animal training apparatus 400, according to the present teachings.

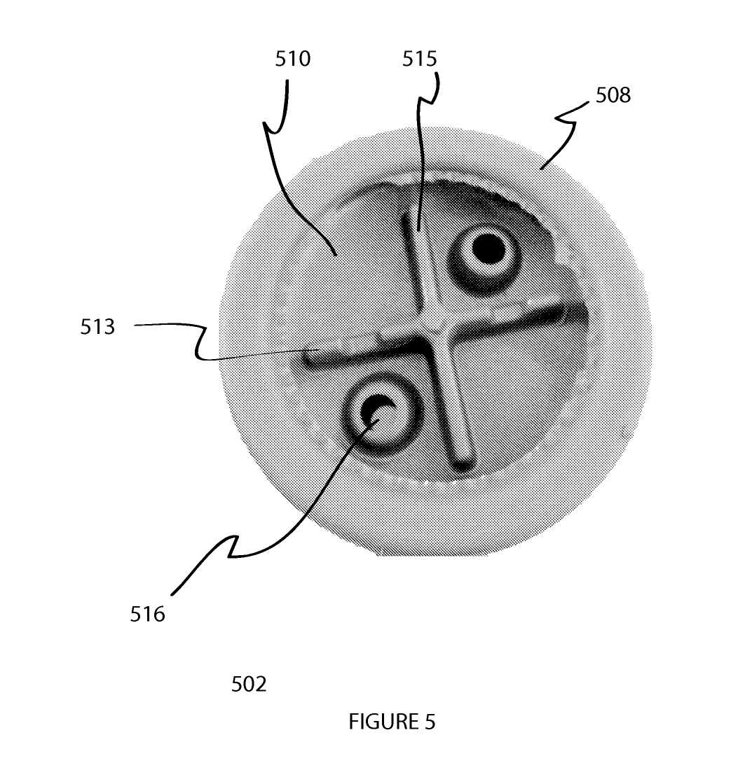

FIG. 5 illustrates top plan view of the inside of a bottom portion 502 of a circumferentially locking embodiment of an animal training apparatus 500, according to the present teachings. As illustrated, the bottom portion 502 comprises a bottom half circumferential locking portion 508, at least one chamber 510, at least one food passage hole 516, a blocking barrier 515, an open barrier 513. It will be appreciated that a human user may put a food treat into any of the four illustrated chambers of this embodiment, prior to circumferentially locking with a top portion (not shown). Once locked, the animal training apparatus 500 become a kind of puzzle, or game for the animal, such that the animal must work to move the food treat into a chamber having an at least one food passage hole 516. In the illustrated exemplary embodiment, if the human user has put the food treat into chamber 510, the food treat will only be able to pass into the chamber having the at least one food passage hole 516, because the blocking barrier 515 will not allow the food treat to pass in the other direction. That is, in order to extract the food treat from the animal training apparatus 500, the animal must work the food treat through the open barrier 513 and then out through the at least one food passage hole 516.

Although embodiments of the present teachings have been described as a pet tool, such as for example a dog tool, the animal training apparatus 500 may be readily adapted for use as a cat tool, or for animals living in captivity in a zoo, such as for example lions, tigers, horses, dolphins and the like.

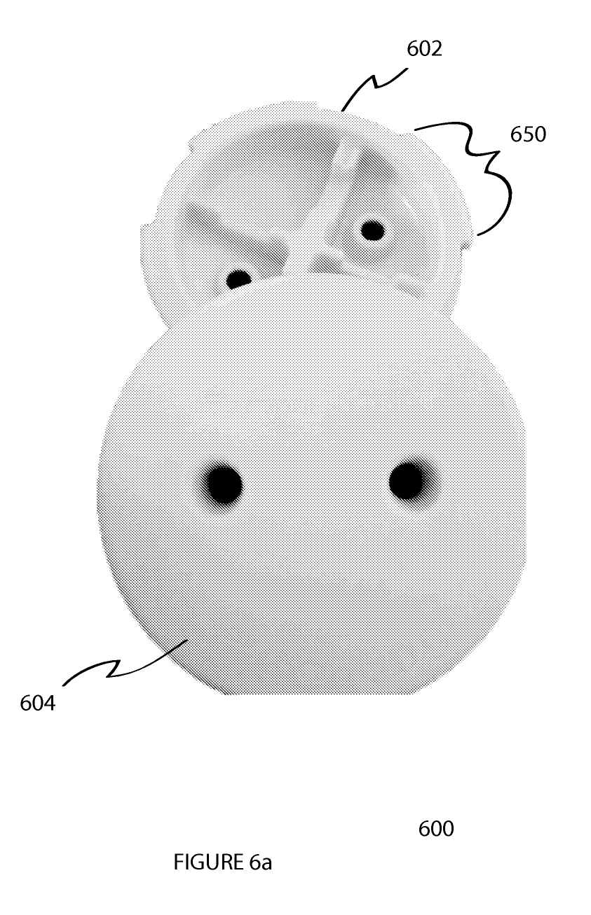

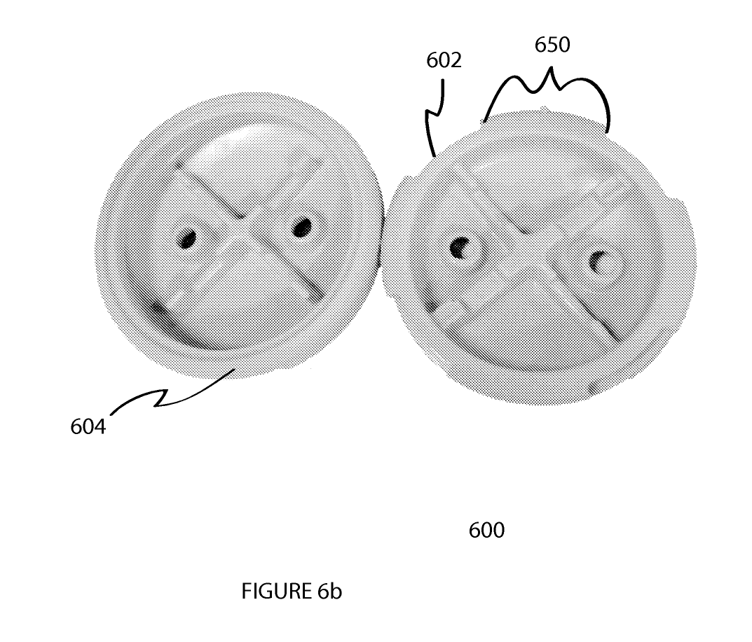

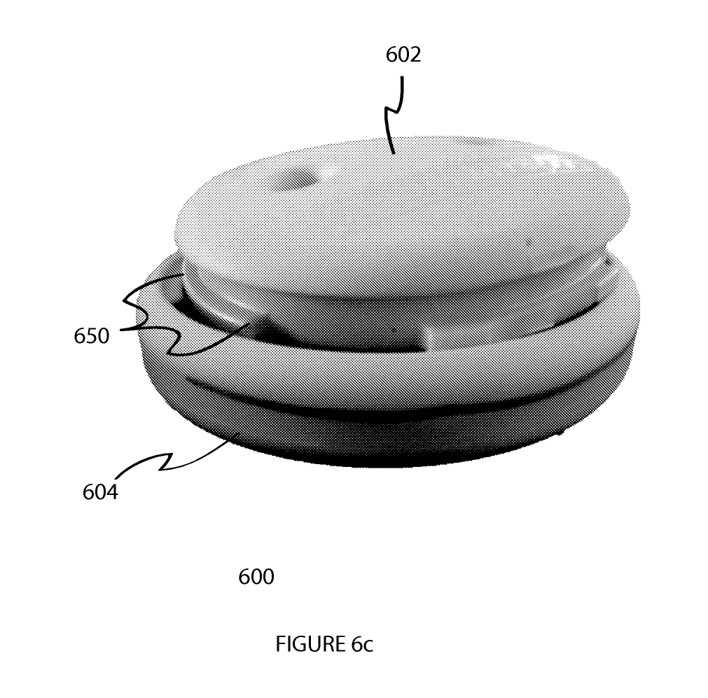

FIG. 6a illustrates a perspective view of disassembled top and bottom halves of an interlocking embodiment of an animal training apparatus 600, according to the present teachings. Although similar to previously described embodiments, this variation employs a different locking mechanism for securing a top portion 604 to a bottom portion 602, by utilizing a plurality of flanges 650 disposed upon the perimeter of the bottom portion 602, to interlock to the top portion 604.

FIG. 6b illustrates a perspective view of the inside of disassembled top and bottom halves of an interlocking embodiment of an animal training apparatus 600, according to the present teachings. As described above with respect to FIG. 6a, a plurality of flanges 650 disposed on the perimeter of the bottom portion 602 functions to interlock to the top portion 604. It will be appreciated that a variety of materials may be used to construct the plurality of flanges 650, however in one embodiment, a hard plastic material is used. Although four flanges are shown, it will be appreciated that this is for exemplary illustrative purposes only and literally any number of flanges may be used without departing from the scope and spirit of the present teachings.

FIG. 6c illustrates a perspective view of disassembled top and bottom halves of an interlocking embodiment of an animal training apparatus 600, according to the present teachings. This illustration shows the interlocking embodiment about to be “locked” into place using the plurality of flanges 650.

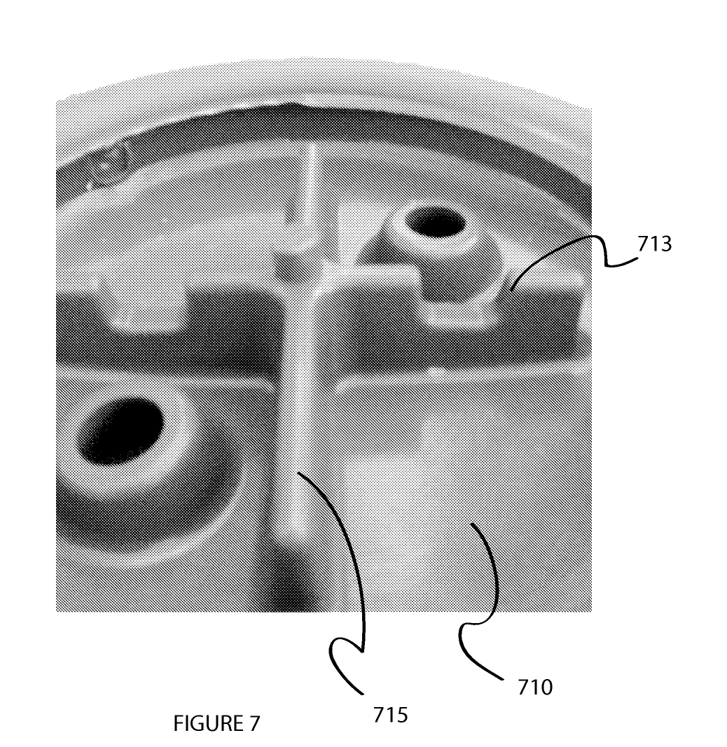

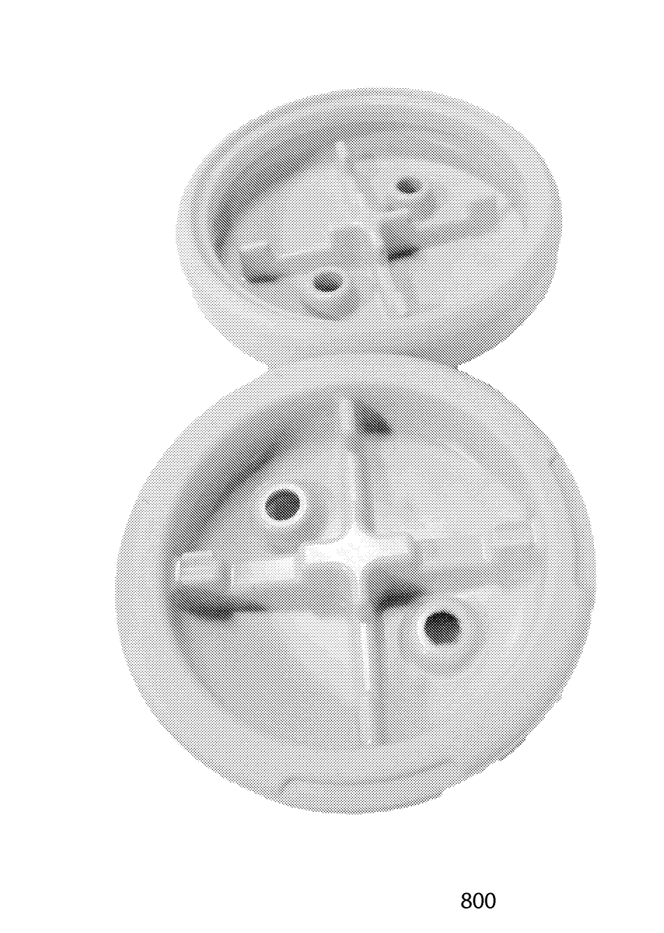

FIG. 7 illustrates a zoomed in perspective view of the inside of one half of a circumferentially locking embodiment of an animal training apparatus 700, illustrating the distinctions between the open barrier 713 and the closed barrier 715 between chambers 710, according to the present teachings.

FIG. 8 illustrates a perspective view of the inside of disassembled top and bottom halves of a circumferential ridge locking embodiment of an animal training apparatus 800, according to the present teachings.

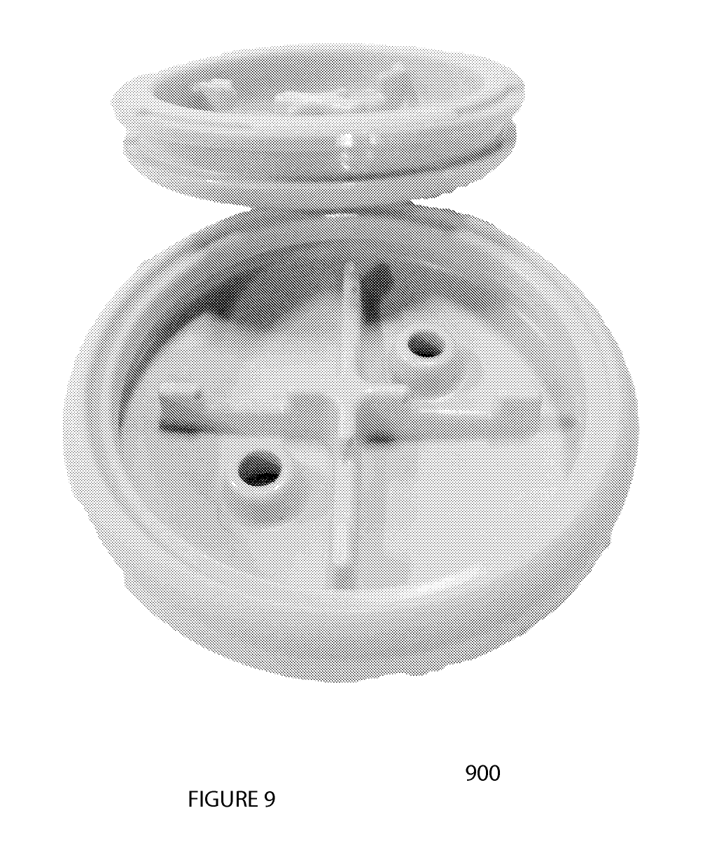

FIG. 9 illustrates a perspective view of disassembled top and bottom halves of a circumferential ridge locking embodiment of an animal training apparatus 900, according to the present teachings.

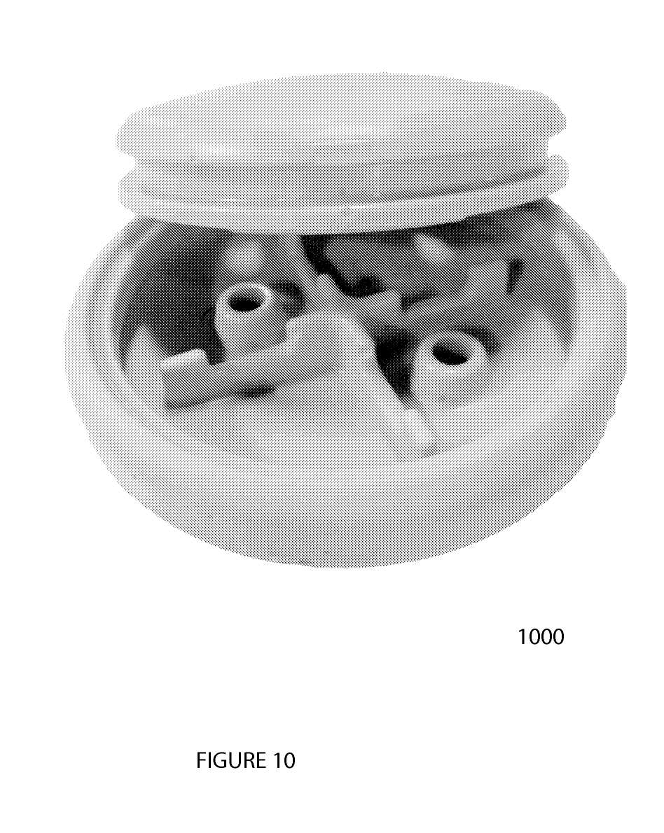

FIG. 10 illustrates a perspective view of disassembled top and bottom halves of a circumferential ridge locking embodiment of an animal training apparatus 1000, according to the present teachings.

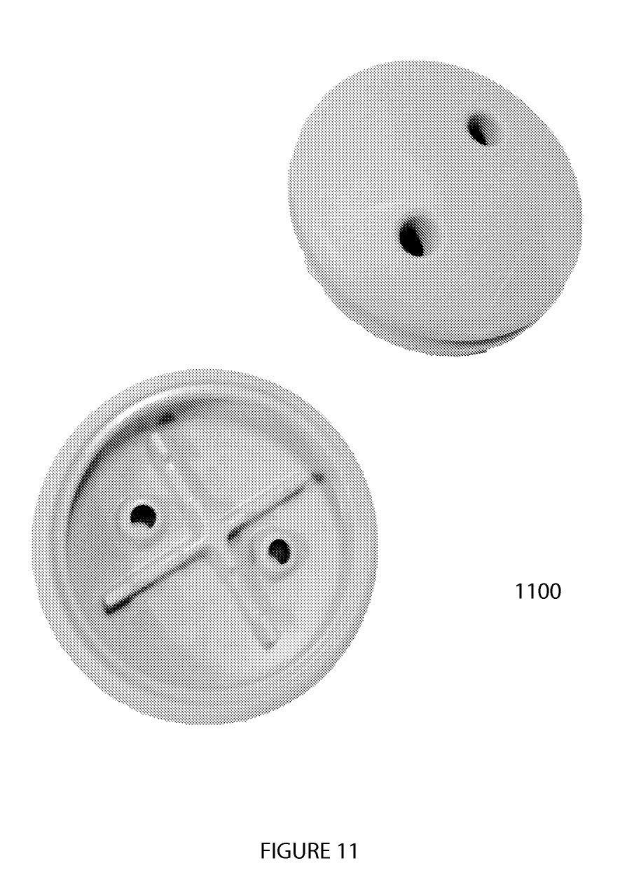

FIG. 11 illustrates a top plan view of disassembled top and bottom halves of a circumferential ridge locking embodiment of an animal training apparatus 1100, according to the present teachings.

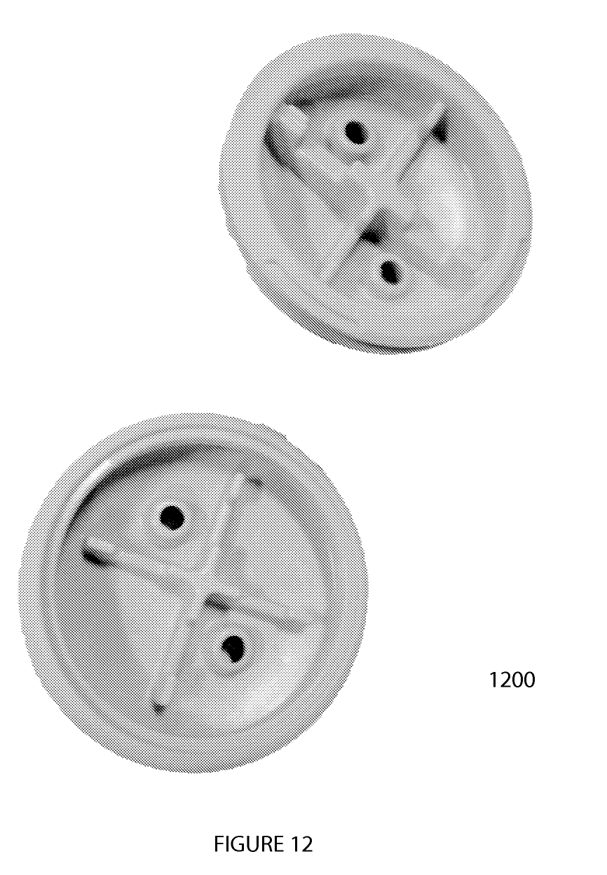

FIG. 12 illustrates a perspective view of the inside of disassembled top and bottom halves of a circumferential ridge locking embodiment of an animal training apparatus 1200, according to the present teachings.

It will be appreciated that although not illustrated, accessories may also be added to the animal training apparatus 700, either to the top or bottom portion. Such accessories may comprise items desirable to a particular animal, such as for example a bone or a ring for a dog exemplary embodiment.

It will be appreciated that embodiments of the present teachings may be used in animal training and obedience as a reward based tool, such as for example using the tool as a reward for a dog once the dog has demonstrated a particular form of obedience.

Materials from which the animal training apparatus is composed are easily sanitized, which is important for shelters where they would have a large number of animal turn over.

It will be appreciated that other animals will benefit from the present disclosure, including wolves, Meer cats, raccoons and the like.

It will be appreciated that the animal training apparatus may be used to train dogs to detect drugs and/or explosives by putting both a specific dog treat and a specific kind of drug and/or explosive material into the animal training apparatus to teach the dog what to sniff for, and to be incentivized to detect such items.

The foregoing description illustrates exemplary implementations, and novel features, of aspects of an animal training apparatus and method. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

What is claimed is:

1.) An animal training apparatus, comprising:
an upper portion, having a plurality of chambers wherein at least one chamber comprises a food passage hole therein, including an open barrier and a closed barrier;
a lower portion, having a plurality of chambers wherein at least one chamber comprises a food passage hole therein, including an open barrier and a closed barrier;
a locking portion, adapted to lock the upper portion and the lower portion in a fixed position with respect to each other.

2.) The apparatus of claim 1, further comprising a reflex action for providing mental stimulation to the animal.

3.) A method of training an animal to detect drugs and/or explosives, comprising:
providing an animal training apparatus adapted to house an animal treat;
providing an incentive for the animal to detect the drug and/or explosive.

4.) A method for relieving separation anxiety in an animal, comprising:
providing an upper portion, having a plurality of chambers wherein at least one chamber comprises a food passage hole therein, including an open barrier and a closed barrier;
providing a lower portion, having a plurality of chambers wherein at least one chamber comprises a food passage hole therein, including an open barrier and a closed barrier;
providing a locking portion, adapted to lock the upper portion and the lower portion in a fixed position with respect to each other.
